(19) United States
(12) Patent Application Publication
(10) Pub. No.: US 2021/0003406 A1
(43) Pub. Date: Jan. 7, 2021

(54) SYSTEMS AND METHODS FOR ESTIMATING A PREDICTION VALUE FOR PROSPECTIVE VEHICLE USAGE

(71) Applicant: Honda Motor Co., Ltd., Tokyo (JP)

(72) Inventor: Kiyotaka Kawashima, Los Angeles, CA (US)

(21) Appl. No.: 16/502,809

(22) Filed: Jul. 3, 2019

(51) Int. Cl. G01C 21/34; G06Q 30/02; B60R 16/023; B60R 16/03

(52) U.S. Cl. CPC G01C 21/343; G01C 21/3469; G01C 21/3492; B60R 16/03; G06Q 30/0206; B60R 16/0231; G01C 21/3476

(57) ABSTRACT

Systems and methods for estimating a prediction value for usage of a prospective vehicle. In one embodiment, a method includes receiving trip log data associated with the driven vehicle. The trip log data includes a first trip having at first duration and a second trip having a second duration traveled by the driven vehicle within a past time period. The method further includes calculating a dwell duration between the first trip and the second trip. The method also includes receiving historical energy pricing for energy. The method yet further includes calculating a historical value for the first trip, the second trip, and the dwell duration, based on the historical energy pricing. The prediction value is estimated for the prospective vehicle for a future time period based on the historical value.

### BACKGROUND

It can be difficult to choose a vehicle given the various features and styles of vehicle models, which are changing every year. This decision is made more difficult when trying to decide between a traditional gas-powered vehicle or adopting a new energy technology such as a hybrid vehicle or an electric vehicle. Consumers generally understand the benefits of moving to a new energy technology. However, consumers may also be apprehensive about integrating a vehicle with a new energy technology into their lives. The apprehension is further magnified by the pace at which new energy technologies are developing. Accordingly, public awareness and education have consistently been some of the biggest barriers to new energy technologies transforming the vehicle market.

### BRIEF DESCRIPTION

According to one aspect, a computer-implemented method for estimating a prediction value for usage of a prospective vehicle includes receiving trip log data associated with the driven vehicle. The trip log data includes a first trip having a first duration and a second trip having a second duration traveled by the driven vehicle within a past time period. The method further includes calculating a dwell duration between the first trip and the second trip. The method also includes receiving historical energy pricing for energy. The method yet further includes calculating a historical value for the first trip, the second trip, and the dwell duration, based on the historical energy pricing. The prediction value is estimated for the prospective vehicle based on the historical value.

According to another aspect, a system for calculating a prediction value for usage of a prospective vehicle includes a data receiving module, a dwell module, a historical module, and a prediction module. The data receiving module receives trip log data associated with the driven vehicle and historical energy pricing. The trip log data includes a first trip having a first duration and a second trip having a second duration occurring within a past time period. The dwell module calculates a dwell duration between the first trip and the second trip. The historical module calculates a historical value for the first trip, the second trip, and the dwell duration, based on the historical energy pricing. The prediction module estimates the prediction value for a future time period based on the historical value.

According to still another aspect, a non-transitory computer readable storage medium stores instructions that, when executed by a computer, which includes at least a processor, causes the computer to perform a method for estimating a prediction value for usage of a prospective vehicle. The method includes receiving trip log data associated with the electric vehicle. The trip log data includes a first trip having a first duration and a second trip having a second duration traveled by the driven vehicle within a past time period. The method further includes calculating a dwell duration between the first trip and the second trip. The method also includes receiving historical energy pricing for energy. The method yet further includes calculating a historical value for the first trip, the second trip, and the dwell duration, based on the historical energy pricing. The prediction value is estimated for the prospective vehicle based on the historical value.

### BRIEF DESCRIPTION OF THE DRAWINGS

FIG. 1 is a schematic view of a driven vehicle in an exemplary traffic scenario according to an exemplary embodiment.

FIG. 2 is a block diagram of an operating environment for estimating a prediction value for an electric vehicle according to an exemplary embodiment.

FIG. 3 is a process flow for estimating a prediction value for a prospective vehicle according to an exemplary embodiment.

FIG. 4 is a block diagram of a data flow for estimating a prediction value according to an exemplary embodiment.

FIG. 5 is an illustration of an example computer-readable medium or computer-readable device including processor-executable instructions configured to embody one or more of the provisions set forth herein, according to one aspect.

### DETAILED DESCRIPTION

To educate consumers about the benefits of adopting a new energy technology, a consumer can be shown the advantages of the new technology in terms of their own life using the systems and methods described herein. For example, a consumer can be shown how an electric vehicle would save the consumer fuel costs or even produce revenue. This information could help consumers choose a vehicle at the point of sale. However, due to privacy concerns, vehicle dealers do not have access to personal identifiable information, such as a consumer's trip logs. Accordingly, the dealer does not have the personal identifiable information needed to calculate the benefits for the consumer.

However, this personal identifiable information does exist. Many vehicles, possibly including a consumer's previous or current vehicle, may maintain personal identifiable information, such as the consumer's trip logs. Without providing the personal identifiable information to a third party (e.g., the dealer), a prediction value can be calculated based on the personal identifiable information for the driven vehicle of the consumer. The prediction value may provide a cost benefit analysis of adopting a new technology, such as electric vehicle ownership. The prediction value may be provided to the consumer or the dealer without detailing the consumer's personal identifiable information. Accordingly, a consumer is provided with the information necessary to make an informed decision while maintaining the consumer's privacy.

### Definitions

The following includes definitions of selected terms employed herein. The definitions include various examples and/or forms of components that fall within the scope of a term and that can be used for implementation. The examples are not intended to be limiting. Furthermore, the components discussed herein, can be combined, omitted, or organized with other components or into different architectures.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) can reside within a process and/or thread. A computer component can be localized on one computer and/or can be distributed between multiple computers.

“Computer communication,” as used herein, refers to a communication between two or more communicating devices (e.g., computer, personal digital assistant, cellular telephone, network device, vehicle, vehicle computing device, infrastructure device, roadside equipment) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication can utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein can include input and/or output devices for receiving input and/or devices for outputting data. The input and/or output can be for controlling different vehicle features, which include various vehicle components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface, which can be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Consumer,” as used herein can include, but is not limited to, one or more entities, such as a human being or business, that has indicated an interest in obtaining some form of ownership of a vehicle. The forms of ownership may include buying, leasing, renting, sharing, etc.

“Database,” as used herein, is used to refer to a table. In other examples, “database” can be used to refer to a set of tables. In still other examples, “database” can refer to a set of data stores and methods for accessing and/or manipulating those data stores. A database can be stored, for example, at a disk, data store, and/or a memory.

“Data store,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “dealer,” as used herein can include, but is not limited to, one or more entities, such as a human being or business, that provide opportunities for ownership of a vehicle, typically through a barter or pecuniary arrangement. The forms of ownership may include buying, leasing, renting, sharing, etc.

“Display,” as used herein can include, but is not limited to, LED display panels, LCD display panels, CRT display, plasma display panels, touch screen displays, among others, that are often found in vehicles to display information about the vehicle. The display can receive input (e.g., touch input, keyboard input, input from various other input devices, etc.) from a user. The display can be accessible through various devices, for example, though a remote system. The display may also be physically located on a portable device, mobility device, or vehicle.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software-controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Operable connection,” or a connection by which entities are “operably connected,” is one in which signals, physical communications, and/or logical communications can be sent and/or received. An operable connection can include a wireless interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry to execute actions and/or algorithms.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

“Vehicle,” as used herein, refers to any moving vehicle that is capable of carrying one or more users and is powered by any form of energy. The term “vehicle” includes, but is not limited to, cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is powered entirely or partially by one or more electric motors powered by an electric battery. The EV can include battery electric vehicles (BEV), plug-in hybrid electric vehicles (PHEV), and extended range electric vehicles (EREVs). The term “vehicle” can also refer to an autonomous vehicle and/or self-driving vehicle powered by any form of energy. The autonomous vehicle can carry one or more users. Further, the term “vehicle” can include vehicles that are automated or non-automated with pre-determined paths or free-moving vehicles.

“Vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, an interior or exterior camera system among others.

### I. System Overview

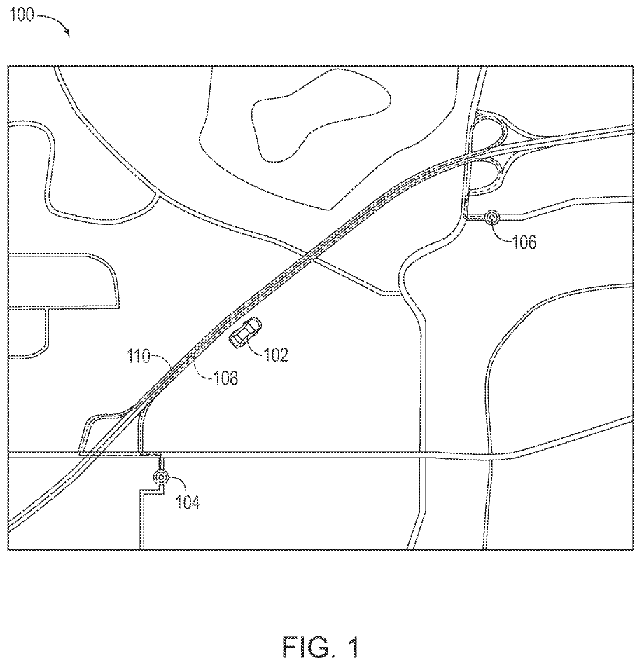

Referring now to the drawings, the showings are for purposes of illustrating one or more exemplary embodiments and not for purposes of limiting the same. FIG. 1 is a schematic view of an exemplary traffic scenario on roadways 100 according to an exemplary embodiment. The roadways 100 can include any type of path, road, highway, freeway, or travel route. The roadways 100 can have various configurations not shown in FIG. 1. For example, the roadways 100 can have any number of lanes or use any number of paths. The roadways 100 are traversed by one or more vehicles, such as a driven vehicle 102.

In FIG. 1, the roadways 100 illustrate paths the driven vehicle 102 can travel from an origin 104 to a destination 106. The driven vehicle 102 is a vehicle currently and/or previously used by a consumer (not shown). Example paths from the origin 104 to and from the destination 106 are illustrated as the first trip 108 and the second trip 110. For example, the driven vehicle 102 embark on the first trip 108 by leaving the origin 104 at a first start time (e.g., 7:50 AM). The first trip 108 may end at the destination 106 at a first end time (e.g., 8:20 AM). Suppose that the origin 104 is a residence of a consumer (not shown) and the destination 106 is a workplace. The first trip 108 may be a commute to work. The second trip 110 may have the driven vehicle 102 return from the destination 106 to the origin 104, for example, as the commute home. Accordingly, the driven vehicle 102 may embark on the second trip 110 at a second start time (e.g., 5:35 PM) and the second trip 110 may end at a second end time (e.g., 6:41 PM).

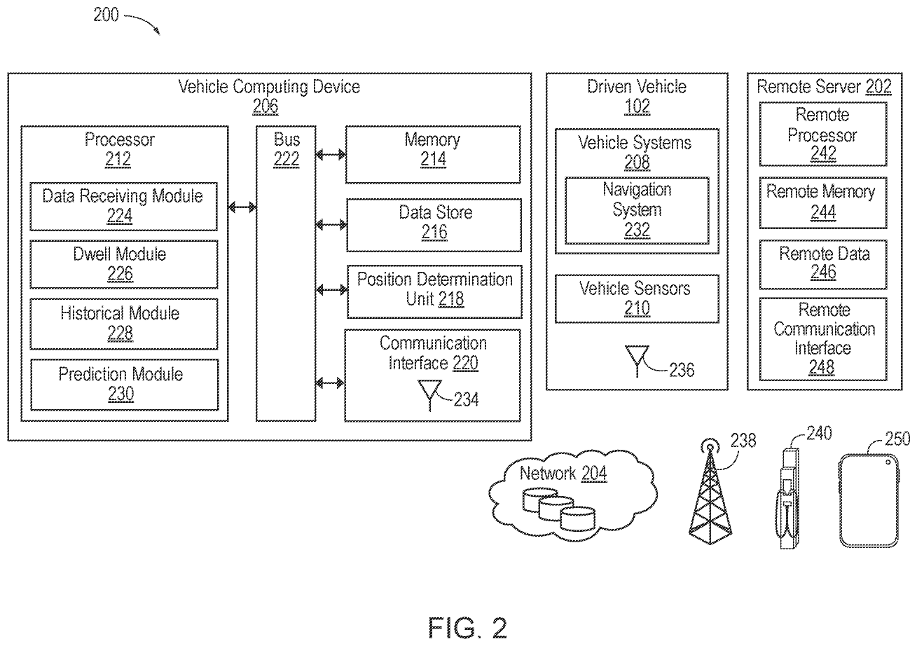

Data about the first trip 108 and the second trip 110 are stored as trip log data. For example, the trip log data may include the location of the origin 104, the destination 106, type of location, amenities of the origin 104 and the destination 106, the first start time, the first end time, the second start time, the second end time, route information, mileage, the travel time period, duration, amenities at the charge location may include covered parking, and access to a charge station, among others. While a single destination is discussed, the driven vehicle 102 may take numerous trips in a single day to multiple destinations. Accordingly, the trip log data may include data about numerous trips over long periods of time (e.g., hours, days, months, years, etc.). The trip log data may be stored and utilized by an operating environment, such as operating environment 200 of FIG. 2.

FIG. 2, a block diagram of the operating environment 200 for estimating a prediction value for a prospective vehicle according to an exemplary embodiment. One or more of the components of the operating environment 200 can be considered in whole or in part a vehicle communication network. The driven vehicle 102 communicates with a remote server 202 over a network 204. A vehicle computing device (VCD) 206 may be provided at the driven vehicle 102, the remote server 202, or other remote location operably connected to the driven vehicle 102 and/or the remote server 202 via the network 204. Vehicle systems 208 and vehicle sensors 210 communicate information about the driven vehicle 102 to the VCD 206.

Generally, the VCD 206 includes a processor 212, a memory 214, a data store 216, a position determination unit 218, and a communication interface 220, which are each operably connected for computer communication via a bus 222 and/or other wired and wireless technologies defined herein. The VCD 206, can include provisions for processing, communicating, and interacting with various components of the driven vehicle 102 and other components of the operating environment 200. In one embodiment, the VCD 206 can be implemented with the driven vehicle 102, for example, as part of a telematics unit, a head unit, an infotainment unit, an electronic control unit, an on-board unit, or as part of a specific vehicle control system, among others. In other embodiments, the VCD 206 can be implemented remotely from the driven vehicle 102, for example, with a portable device 250 or the remote server 202, connected via the network 204.

The processor 212 can include logic circuitry with hardware, firmware, and software architecture frameworks for remote control of the driven vehicle 102 by multiple operators. Thus, in some embodiments, the processor 212 can store application frameworks, kernels, libraries, drivers, application program interfaces, among others, to execute and control hardware and functions discussed herein. For example, the processor 212 can include a data receiving module 224, a dwell module 226, a historical module 228, and a prediction module 230, although it is understood that the processor 212 can be configured into other architectures. The memory 214 and/or the data store 216 may store data about the driven vehicle 102, such as the trip log data. Further, in some embodiments, the memory 214 and/or the data store 216 can store similar components as the processor 212 for execution by the processor 212.

The modules of the processor 212 may access the position determination unit 218 via the bus 222. The position determination unit 218 can include hardware (e.g., sensors) and software to determine and/or acquire position data about the driven vehicle 102. For example, the position determination unit 218 can include a global positioning system (GPS) unit (not shown) and/or an inertial measurement unit (IMU) (not shown). Thus, the position determination unit 218 can provide a geo-position of the driven vehicle 102 based on satellite data from, for example, a global position source (not shown), or from any Global Navigational Satellite infrastructure (GNSS), including GPS, Glonass (Russian) and/or Galileo (European). Further, the position determination unit 218 can provide dead-reckoning data or motion data from, for example, a gyroscope, accelerometer, magnetometers, among other vehicle sensors 210. In some embodiments, the position determination unit 218 can be a component of the navigation system 232 of the vehicle systems 208 that provides navigation maps and navigation information to the driven vehicle 102.

The communication interface 220 can include software and hardware to facilitate data input and output between the components of the VCD 206 and other components of the operating environment 200. Specifically, the communication interface 220 can include network interface controllers (not shown) and other hardware and software that manages and/or monitors connections and controls bi-directional data transfer between the communication interface 220 and other components of the operating environment 200 using, for example, the network 204.

More specifically, in one embodiment, the VCD 206 can exchange data and/or transmit data, such as the trip log data, with other operably connected devices via a transceiver 234 or other communication hardware and protocols. For example, the transceiver 234 can exchange data with a vehicle occupant, consumer, or manufacturer of the driven vehicle 102. In some embodiments, the driven vehicle 102 can also exchange data (e.g., trip log data as will be described herein) over remote networks by utilizing a wireless network antenna 236, roadside equipment 238, an charging station 240 and/or the network 204 (e.g., a wireless communication network), or other wireless network connections.

Referring again to the driven vehicle 102, the vehicle systems 208 can include any type of vehicle control system and/or vehicle described herein to enhance the driven vehicle 102 and/or driving of the driven vehicle 102. For example, the vehicle systems 208 can include autonomous driving systems, remote control systems, driver-assist systems, adaptive cruise control systems, or any other advanced driving assistance systems (ADAS). Here, the vehicle systems 208 may include a navigation system 232. The navigation system 232 stores, calculates, and provides route and destination information and facilitates features like turn-by-turn directions.

The vehicle sensors 210, which can be implemented with the vehicle systems 208, can include various types of sensors for use with the driven vehicle 102 and/or the vehicle systems 208 for detecting and/or sensing a parameter of the driven vehicle 102, the vehicle systems 208, and/or the environment surrounding the driven vehicle 102. For example, the vehicle sensors 210 can provide data about vehicles and/or downstream objects in proximity to the driven vehicle 102. For example, the vehicle sensors 210 can include, but are not limited to: acceleration sensors, speed sensors, braking sensors, proximity sensors, vision sensors, ranging sensors, seat sensors, seat-belt sensors, door sensors, environmental sensors, yaw rate sensors, steering sensors, GPS sensors, among others. It is also understood that the vehicle sensors 210 can be any type of sensor, for example, acoustic, electric, environmental, optical, imaging, light, pressure, force, moisture, thermal, temperature, proximity, among others.

Using the system and network configuration discussed above, a prediction value of the benefit ownership and/or usage of a prospective vehicle can be estimated based on the trip log data of the driven vehicle 102. The prediction value may be provided to a consumer to help educate the consumer about the costs and benefits of adopting a new technology by, for example, buying an electric vehicle. Detailed embodiments describing exemplary methods using the system and network configuration discussed above will now be discussed in detail.

### II. Methods for Estimating a Prediction Value

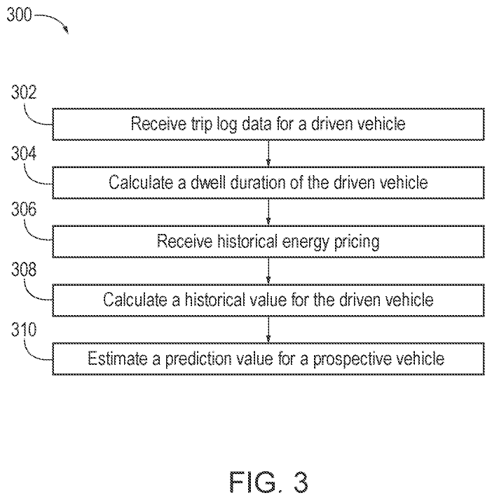

Referring now to FIG. 3, a method 300 for estimating a prediction value for usage of a prospective vehicle according to an exemplary embodiment. FIG. 3 will also be described with reference to FIGS. 1, 2, 4, and 5. As shown in FIG. 3, the method 300 can be described by a number of steps for estimating a prediction value for an electric vehicle. For simplicity, the method 300 will be described by these steps, but it is understood that the steps of the method 300 can be organized into different architectures, blocks, stages, and/or processes.

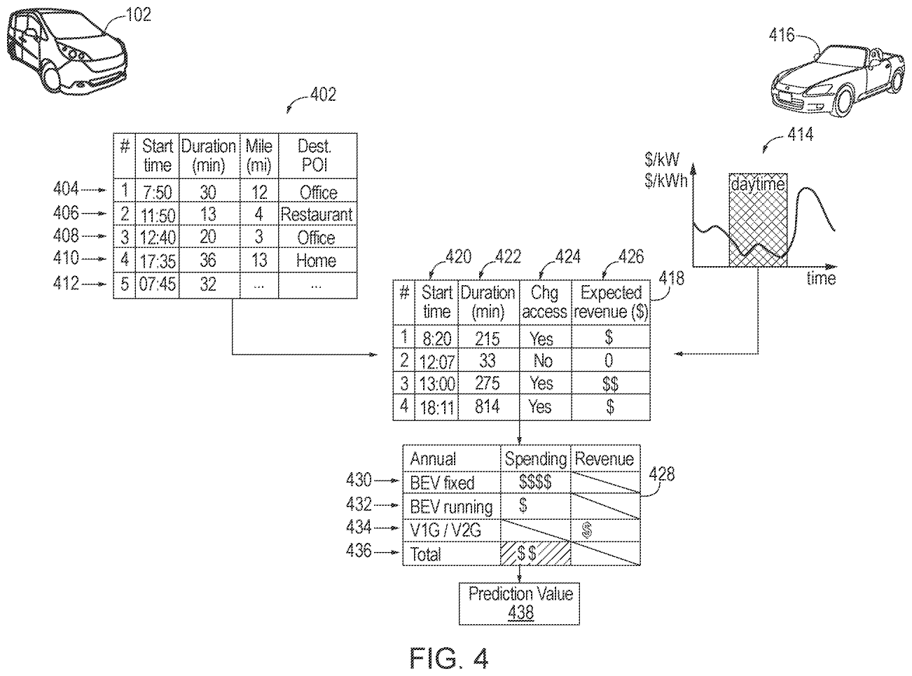

At block 302, the method 300 includes the data receiving module 224 receiving trip log data associated with the driven vehicle 102. The trip log data may be received from the driven vehicle 102, the remote server 202, and/or the portable device 250 over the network 204. For example, the driven vehicle 102 may maintain trip log data in a trip log 402, as shown in FIG. 4. The trip log 402 may include trip log data regarding one or more of the trips made by the driven vehicle 102. For example, the trip log data may include the first trip 108 and the second trip 110 such as the origin 104, the destination 106, the start time, the end time, the duration, the mileage, the type of location, etc.

The remote server 202 may include a remote processor 242 and a remote memory 244 that generate and/store trip log data stored as the remote data 246. In one embodiment, the data receiving module 224 may access the remote data 246 via the remote communications interface 248 to access the trip log data.

The data receiving module 224 may receive the trip log data as the trip log 402. Additionally, the data receiving module 224 may also query and/or access trip log data on the driven vehicle 102, the remote server 202, and/or the portable device 250. In another embodiment, the data receiving module 224 may calculate trip log data. For example, the data receiving module 224 may receive location data from the position determination unit 218 and identify a location of the origin 104 or the destination 106, thereby generating trip log data. As another example, the data receiving module 224 may calculate mileage or location type based on information from the navigation system 232. Accordingly, trip log data can be generated and received by the data receiving module 224.

The trip log data may also include a driving profile associated with the driven vehicle 102. For example, the trip log data may include information about the manner in which the consumer operates the driven vehicle 102. Additionally or alternatively, the data receiving module 224 may determine a driving profile or supplement a driving profile based on the data received in the trip log data, the vehicle systems 208, or the vehicle sensors 210. For example, suppose that the driving profile includes categorizations of the consumer's driving style (e.g., power, sporty, aggressive, relaxed, fuel efficient, etc.), the data receiving module 224 may receive braking data from the vehicle sensors 210 to identify the consumer's driving style. Accordingly, the data receiving 224 module may assess and/or generate profile data associated with a driving profile based on vehicle data from the vehicle systems 208 and/or the vehicle sensors 210. In this manner, the trip log data may address the consumer's style of driving, in addition to the driven vehicle 102.

At block 304, the method 300 includes calculating a dwell duration between the first trip 108 and the second trip 110. The dwell duration is the amount of time that the driven vehicle 102 remained at a location between trips. Therefore, the dwell module 226 may define the start times and end times of trips. For example, the dwell module 226 may calculate the dwell duration for the driven vehicle 102 when the driven vehicle 102 is stationery. Accordingly, the end time of the first trip 108 may be when the driven vehicle 102 has reached the destination 106 and is stationery. The start time of the second trip may be when the driven vehicle 102 begins moving.

In another embodiment, the dwell module 226 may consider the first trip 108 to have ended once the driven vehicle 102 has been inactive (e.g., stationery, idling, in an off-state, etc.) for a predetermined amount of time. For example, the dwell module 226 may define that the driven vehicle 102 be inactive for 10 minutes before an end time of the first trip 108 can be identified. To determine the driven vehicle 102 is inactive, the dwell module 226 may receive vehicle data from the vehicle systems 208 and/or the vehicle sensors 210. Accordingly, once the driven vehicle 102 has been active for ten minutes, the data dwell module 226 may receive trip log data from the data receiving module 224 and/or vehicle data from the vehicle systems 208 and/or the vehicle sensors 210 to determine when the driven vehicle 102 first became inactive and identify the end time of the first trip 108 accordingly.

The dwell module 226 calculates the dwell duration using the received trip log data including any generated trip log data. Returning to the example discussed above with respect to FIG. 1, suppose that the first trip 108 ends at the destination 106 at a first end time (e.g., 8:20 AM) and the consumer embarks on the second trip 110 at a second start time (e.g., 5:35 PM). The dwell duration is calculated as the time between the first end time (e.g., 8:20 AM) and second start time (e.g., 5:35 PM). Accordingly, in this example the dwell duration is 9 hours and 15 minutes. While the example is given in hours and minutes, other values of granularity may be used, for example, the dwell duration may be calculated in days, hours, minutes, seconds, or any combination thereof. Alternatively, the dwell duration may be calculated as a portion of a day or in increments. For example, if the dwell duration is calculated in 15 minute increments, then the dwell duration from the example above would be calculated as 37 increments.

For clarity, the example is between the first trip 108 and the second trip 110. However, a plurality of dwell durations may be calculated for the driven vehicle 102 over a historical time period. For example, each of the dwell durations for the driven vehicle 102 may be calculated over the course of the previous year. Furthermore, different types of data may be used to calculate the dwell duration. For example, a start time and a duration of the trip may be used to calculate dwell durations.

Turning to the trip log 402 from the driven vehicle 102 of FIG. 4, suppose the trip log data is received by the receiving module 224 as a trip log 402 detailing a plurality of trips. In this example, the trip log 402 the rows are indicative of a first trip log trip 404, a second trip log trip 406, a third trip log trip 408, a fourth trip log trip 410, and a fifth trip log trip 412. Here, the start time and travel duration of each of the trips is given. For example, the first trip log trip 404 has a first trip start time of 7:50 and lasts 30 minutes. Thus, the first trip log trip 404 ends at 8:20. The second trip log trip 406 starts at 11:55. Accordingly, at block 304 the first dwell duration would be calculated as 3 hours and 35 minutes. The second trip log trip 406 lasts 13 minutes, and therefore ends at 12:08. The third trip log trip 408 starts at 12:40. Accordingly, the second dwell duration would be calculated as 32 minutes. In a similar manner, a third dwell duration may be calculated as 4 hours and 35 minutes between the third trip log trip 408 and the fourth trip log trip 410, and a fourth dwell duration may be calculated as 13 hours and 34 minutes between the fourth trip log trip 410 and the fifth trip log trip 412. Accordingly, the dwell duration may be calculated based on when the driven vehicle is active use by the consumer, specifically, in this embodiment, on the duration of the trips.

In this manner, a plurality of dwell durations are calculated between the trips of the N trips. Therefore, any number of dwell durations may be calculated using the trip log data. During the dwell duration the driven vehicle 102 may not be used for traveling by the consumer. However, the driven vehicle may be used for other purposes. For example, another user may use the driven vehicle 102 for peer-to-peer ride sharing. The driven vehicle 102 may remain stationery at the location. For example, suppose the driven vehicle 102 has been driven to the destination 106. The destination 106 may be equipped for vehicle to grid (V2G) charging using the charging station 240. Thus, during the dwell duration, the driven vehicle 102 may provide energy to the grid. Accordingly, the dwell durations may be calculated based on the dwell module 226 determining whether the driven vehicle 102 is active or inactive with respect to a consumer. Uses of the driven vehicle 102 may be categorized by the dwell module 226. For example, transporting the consumer may be considered an active use of the driven vehicle 102, while sharing and charging may be deemed inactive uses. The dwell module 226 may only calculate a dwell duration for the driven vehicle 102 when the use of the driven vehicle 102 is deemed inactive.

At block 306, the method 300 includes the data receiving module 224 receiving historical energy pricing 414 for energy during the past time period. In particular, the historical energy pricing 414 is received for the times corresponding to the trips, such as the first trip 108, the second trip 110, the first trip log trip 404, the second trip log trip 406, the third trip log trip 408, the fourth trip log trip 410, and the fifth trip log trip 412. The historical energy pricing 414 includes a cost of the energy supplied to or received from vehicles that are similar to a prospective vehicle 416.

Suppose the prospective vehicle 416 is an electric vehicle and that the historical energy pricing 414 includes values associated with the price per kilowatt. The historical energy pricing 414 may include information about the price per kilowatt-hour of energy to charge the prospective vehicle 416. The historical energy pricing 414 may also include the price per kilowatt-hour of energy provided to the prospective vehicle 416 in order to reach a target state of charge or a provided level of charge of the prospective vehicle during the past time period. The historical energy pricing 414 may include values that are indicative of the price per kilowatt-hour based on the time of year, the day of the week, the time of day, etc. For example, the price per kilowatt-hour may be lower during the day time; this may be reflected in the historical energy pricing 414. Additionally or alternatively, the historical energy pricing 414 may be an average of these values.

In addition to the cost of energy, the historical energy pricing 414 may include revenue for suppling the energy from the prospective vehicle 416. Continuing the example from above in which the prospective vehicle 416 is an electric vehicle, the historical energy pricing 414 may include the revenue generated when the prospective vehicle 416 supplies energy to other vehicles or to the grid. For example, during a dwell duration calculated for the driven vehicle 102, a similarly situated prospective vehicle 416 may have been able to provide energy to other vehicles or to the grid using a charging station 240. Accordingly, the historical energy pricing 414 may include values indicative of revenue that the prospective vehicle 416 would have earned during the dwell durations.

At block 308, the method 300 includes the historical module 228 calculating a historical value 428 for the first trip, the second trip, and the dwell duration, based on the historical energy pricing 414. For example, determining the target state of charge may include evaluating the trip log data of the driven vehicle 102 and determining a driving profile associated with the driven vehicle 102. Based on the historical energy pricing 414, the historical value 428 is indicative of the cost that would have been generated or incurred by the prospective vehicle 416 had the prospective vehicle 416 made the trip or engaged in dwell duration that the driven vehicle 102 did. For example, the historical module 228 may calculate the historical value 428 by applying the historical energy pricing to the fuel and/or charge expended by the driven vehicle during a trip, such as the first trip log trip 404 and/or the second trip log trip 406. In particular, the historical pricing may include an average price per kilowatt-hour of energy to charge the prospective vehicle 416 to reach a target state of charge or a provided level of charge during the past time period. The historical module 228 may determine the target state of charge by evaluating the trip log data of the driven vehicle 102 and determining a driving profile associated with the prospective vehicle 416 based on the evaluation. In this manner, the historical value 428 estimates the cost and/or revenue potential of the prospective vehicle 416 in terms of the consumer's use of the driven vehicle 102 for the past period in which the driven vehicle 102 was used by the consumer.

In some embodiments, the historical module 228 may calculate the historical value 428 using a historical revenue estimate 418 for the dwell durations. The historical revenue estimate 418 is shown as a table, but may be a chart, graph, calculation, equation, and/or algorithm, among others. The historical revenue estimate 418 may include estimates per trip. For example, the historical revenue estimate 418 may include embarkation column 420, a duration length column 422, an amenities column 424, and/or a per trip estimate column 426. The duration length between the first trip log trip 404 and the second trip log trip 406 may have a start time of 8:20 AM in the embarkation column 420 and a dwell duration of 215 minutes in the duration length column 422. As discussed above, the trip log data may indicate whether the driven vehicle 102 would have had access to a charging station 240 in the amenities column 424. Accordingly, the historical module 228 may use the trip log data to calculate the historical value based on the N trips in the trip log including and the plurality of dwell durations are calculated between the trips of the N trips. In some embodiments, because the historical pricing changes throughout the day, week, and/or season, each of the N trips may be associated with a revenue value in per trip estimate column 426.

The revenue value may be a positive, neutral, or negative value or one of various levels. The revenue value for a trip may also be a dollar amount, a category, or calculation based on the factors existing at the time of the trip. For example, returning to the dwell duration of 215 minutes in the duration length column 422 between the first trip log trip 404 and the second trip log trip 406, the historical pricing may be applied to the dwell duration of 215 minutes. The revenue value may be based on the revenue generated by providing charge from the driven vehicle 102 during the dwell duration of 215 minutes. In this manner, a revenue value can be calculated specifically for the dwell durations.

The historical module 228 may calculate the historical value 428 by aggregating the historical energy pricing 414, the historical revenue estimate 418, one or more revenue values, etc. For example, here the historical value 428 is shown as a chart that illustrates the cost benefit analysis that operating the prospective vehicle 416 would have incurred in the past period had the prospective vehicle 416 been used instead of the driven vehicle 102. The historical module 228 may aggregate information for each of the N trips to identify a fixed cost associated with include a fixed cost row 430, a running cost row 432, a charge row 434 which are summed in a total row 436. The fixed cost row 430 may include spending and/or revenue fixed costs associated with the driven vehicle 102 and/or the prospective vehicle 416. For example, the fixed cost row 430 may include the cost of purchasing and/or maintaining the prospective vehicle 416. The running cost row 432 may include spending and/or revenue costs associated with the driven vehicle 102 and/or the prospective vehicle 416. For example, the running cost row 432 may include the fuel costs of driving the driven vehicle 102 and/or charging the prospective vehicle 416. The charge row 434 may include spending and/or revenue costs associated with receiving charge from the driven vehicle 102 and/or the prospective vehicle 416. For example, the charge row 434 may include the revenue for charging the grid or other vehicles from the driven vehicle 102 and/or the prospective vehicle 416 based on a target state of charge or a provided level of charge. These among other factors can be aggregated to calculate the historical value 428.

At block 310, the method 300 includes the prediction module 230 estimating the prediction value 438 for prospective vehicle 416 based on the historical value 428. The prediction value 438 communicates the advantages and or disadvantages of driving the prospective vehicle 416. The prediction value 438 may be estimated based on differences between the past time period and a current or future time period. For example, estimating the prediction value 438 includes receiving current market energy pricing. Accordingly, the historical value 428 may updated or modified based on current market energy pricing to estimate the prediction value for a current or a future time period.

The prediction value 438 may be a single value or a series of values. For example the prediction value 438 may be a score, such as a value on a range. Conversely the prediction value may be a full cost benefit analysis of usage and/or ownership of the prospective vehicle 416 at a current time or during the future time. For example, the prediction value 438 may emulate the historical value 428, but with updated information for the current and/or future time. Therefore, like the historical value 428, the prediction value 438 may be a table, chart, graph, calculation, equation, and/or algorithm, among others.

The prediction value 438 may then be provided to a potential consumer for the prospective vehicle 416 or a dealer of the prospective vehicle 416. Accordingly, the prediction value may be used to educate a consumer about the benefits of a prospective vehicle 416 as compared to their driven vehicle 102. For example, the consumer can be shown the potential financial costs and benefits of driving the prospective vehicle in the future, but in terms of their previous and/or current driving habits, destinations, and routines. In this manner, the consumer can better understand the benefits of usage and/or ownership of the specific prospective vehicle 416. This information could help consumers choose the prospective vehicle 416 at the point of sale with a better understanding of how the prospective vehicle 416 would fit the consumer's lifestyle. Furthermore, because the prediction value 438 is an extrapolated estimation, the prediction value 438 can be provided to the consumer and/or dealer without the underlying data, such as the trip log data. Thus, the prediction value 438 can be provided without including any of the consumer's personal identifiable information, thereby alleviating privacy concerns.

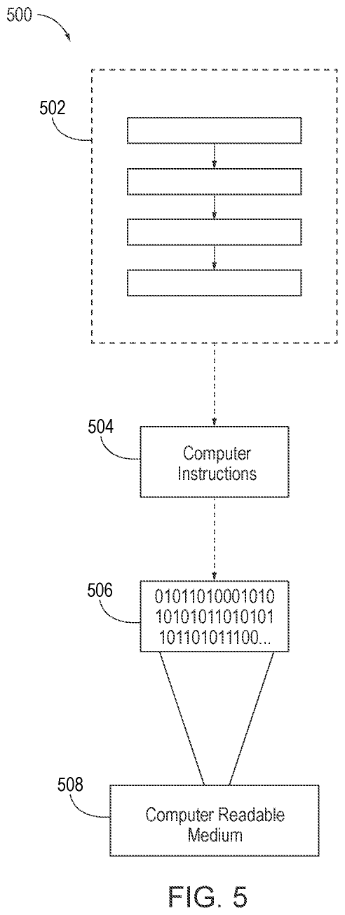

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This encoded computer-readable data 506, such as binary data including a plurality of zero's and one's as shown in 506, in turn includes a set of processor-executable computer instructions 504 configured to operate according to one or more of the principles set forth herein. In this implementation 500, the processor-executable computer instructions 504 may be configured to perform a method 502, such as the method 300 of FIG. 3. In another aspect, the processor-executable computer instructions 504 may be configured to implement a system, such as the operating environment of FIG. 2 and FIG. 4. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

The embodiments discussed herein may also be described and implemented in the context of computer-readable storage medium storing computer executable instructions. Computer-readable storage media includes computer storage media and communication media. For example, flash memory drives, digital versatile discs (DVDs), compact discs (CDs), floppy disks, and tape cassettes. Computer-readable storage media may include volatile and nonvolatile, removable and non-removable media implemented in any method or technology for storage of information such as computer readable instructions, data structures, modules or other data. Computer-readable storage media excludes non-transitory tangible media and propagated data signals.

1. A computer-implemented method for calculating a prediction value for usage of a prospective vehicle, comprising:
receiving trip log data including a first trip having at first duration and a second trip having a second duration traveled by a driven vehicle within a past time period;
calculating a dwell duration between the first trip and the second trip;
receiving historical energy pricing for energy;
calculating a historical value for the first trip, the second trip, and the dwell duration, based on the historical energy pricing; and
estimating the prediction value for the prospective vehicle for a future time period based on the historical value.

2. The computer-implemented method of claim 1, wherein the historical energy pricing includes an average price per kilowatt-hour of energy to charge the prospective vehicle to reach a target state of charge or a provided level of charge during the past time period.

3. The computer-implemented method of claim 2, wherein determining the target state of charge includes evaluating the trip log data of the driven vehicle and determining a driving profile associated with the prospective vehicle based on the evaluation.

4. The computer-implemented method of claim 1, wherein estimating the prediction value includes receiving current market energy pricing, and updating the historical value based on the current market energy pricing.

5. The computer-implemented method of claim 1, wherein the first duration begins at a first start time and ends at a first end time, wherein the second duration begins at a second start time and ends at a second end time, and wherein the dwell duration begins at the first end time and ends at the second start time.

6. The computer-implemented method of claim 1, wherein calculating the historical value for the dwell duration includes determining whether the prospective vehicle has access to a charging station.

7. The computer-implemented method of claim 1, wherein the trip log data includes navigation system data received from a portable device.

8. The computer-implemented method of claim 1, wherein the historical value is further calculated for N trips in the trip log data, and wherein a plurality of dwell durations are calculated between trips of the N trips.

9. The computer-implemented method of claim 1, further comprising:
providing the prediction value for the future time period to a dealer of prospective vehicles, wherein the prediction value is a cost benefit analysis of prospective vehicle ownership.

10. A system for calculating a prediction value for usage of a prospective vehicle, comprising:
a data receiving module receives trip log data associated with a driven vehicle and historical energy pricing for energy, wherein the trip log data includes a first trip having at first duration and a second trip having a second duration traveled by the driven vehicle within a past time period;
a dwell module calculates a dwell duration between the first trip and the second trip;
a historical module calculates a historical value for the first trip, the second trip, and the dwell duration, based on the historical energy pricing; and
a prediction module estimates the prediction value for a future time period based on the historical value.

11. The system of claim 10, wherein the historical module calculating the historical value for the dwell duration includes determining whether the prospective vehicle has access to a charging station.

12. The system of claim 10, wherein the trip log data includes navigation system data received from a portable device.

13. The system of claim 10, wherein the historical module calculated for N trips in the trip log data, and wherein a plurality of dwell durations are calculated between trips of the N trips.

14. The system of claim 10, wherein the prediction module updates the historical value based on current market energy pricing to estimate the prediction value for the future time period.

15. The system of claim 10, wherein the prediction module further provides the prediction value for the future time period to a dealer of prospective vehicles, wherein the prediction value is a cost benefit analysis of prospective vehicle ownership.

16. A non-transitory computer readable storage medium storing instructions that, when executed by a computer, which includes at least a processor, causes the computer to perform a method for estimating a prediction value for usage of a prospective vehicle, the method comprising:
receiving trip log data associated with the prospective vehicle, wherein the trip log data includes a first trip having at first duration and a second trip having a second duration occurring within a past time period;
calculating a dwell duration between the first trip and the second trip;
receiving historical energy pricing for energy;
calculating a historical value for the first trip, the second trip, and the dwell duration, based on the historical energy pricing; and
estimating the prediction value for a future time period based on the historical value.

17. The non-transitory computer readable storage medium of claim 16, wherein the first duration begins at a first start time and ends at a first end time, wherein the second duration begins at a second start time and ends at a second end time, and wherein the dwell duration begins at the first end time and ends at the second start time.

18. The non-transitory computer readable storage medium of claim 16, wherein calculating the historical value for the dwell duration includes determining whether the prospective vehicle has access to a charging station.

19. The non-transitory computer readable storage medium of claim 16, wherein the trip log data includes navigation system data received from a portable device.

20. The non-transitory computer readable storage medium of claim 16, wherein the historical value is further calculated for N trips in the trip log data, and wherein a plurality of dwell durations are calculated between trips of the N trips.
